(19) United States
(12) Patent Application Publication
(10) Pub. No.: US 2026/0201645 A1
(43) Pub. Date: Jul. 16, 2026

(54) DECORATIVE SHEET AND DECORATIVE MEMBER

(71) Applicant: Dai Nippon Printing Co., Ltd., Tokyo (JP)

(72) Inventors: Emi Nissato, Tokyo (JP); Hironaga Usui, Tokyo (JP)

(73) Assignee: Dai Nippon Printing Co., Ltd., Tokyo (JP)

(21) Appl. No.: 19/131,027

(22) PCT Filed: Mar. 12, 2024
(86) PCT No.: PCT/JP2024/009539

§ 371 Date: May 19, 2025

(30) Foreign Application Priority Data
Mar. 30, 2023 (JP) 2023-055640
Sep. 13, 2023 (JP) 2023-148259

(51) Int. Cl. D21H 19/66; B44F 9/02; D21H 19/82

(52) U.S. Cl. CPC D21H 19/66; D21H 19/82; B44F 9/02

(57) ABSTRACT

The present disclosure provides a decorative sheet comprising a substrate layer, a design layer, a protective layer, and a raised layer including a raised portion in a pattern, in this order in a thickness direction, wherein a 60° gloss value of the protective layer is less than a 60° gloss value of the raised layer; the 60° gloss value of the raised layer is 20 or less; in the thickness direction, a ratio of an area of the raised layer, with respect to an area of the protective layer, is 10% or more; and an average distance between adjacent raised portions is 1.6 mm or more.

### TECHNICAL FIELD

The present disclosure relates to a decorative sheet and a decorative member.

### BACKGROUND ART

In order to impart designability to the surface of, for example, construction materials and furniture, a decorative member including a base member and a decorative sheet is used.

The decorative sheet includes, for example, a design layer and a surface protective layer on a substrate layer. Further, in order to obtain texture, it has been proposed to provide a raised portion on the surface of the decorative sheet (Patent Document 1).

### CITATION LIST

### Patent Document

Patent Document 1: Japanese Patent Application Laid-Open (JP-A) No. 2008-87158

### SUMMARY OF DISCLOSURE

### Technical Problem

In recent years, there has been a demand for decorative sheets with a strong rough texture. A strong texture may be imparted by including beads with large particle size in the raised portion. Meanwhile, when beads with large particle size are included in the raised portion, the raised portion becomes highly glossy, resulting in an unnatural design that is not authentic. For this reason, there are demands for decorative sheets having strong texture in the raised portion, while being authentic.

The present disclosure has been made in view of the above circumstances, and a main object of the present disclosure is to provide a decorative sheet having strong texture while being authentic.

### Solution to Problem

The present disclosure provides a decorative sheet comprising a substrate layer, a design layer, a protective layer, and a raised layer including a raised portion in a pattern, in this order in a thickness direction, wherein a 60° gloss value of the protective layer is less than a 60° gloss value of the raised layer; the 60° gloss value of the raised layer is 20 or less; in the thickness direction, a ratio of an area of the raised layer, with respect to an area of the protective layer, is 10% or more; and an average distance between adjacent raised portions is 1.6 mm or more.

The present disclosure provides a decorative member comprising: a base member; and the decorative sheet described above.

### Advantageous Effects of Disclosure

The present disclosure exhibits effects that a decorative sheet having strong texture while being authentic may be provided.

### BRIEF DESCRIPTION OF DRAWINGS

FIG. 1 is a schematic cross-sectional view exemplifying a decorative sheet in the present disclosure.

FIG. 2 is a schematic top view exemplifying a decorative sheet in the present disclosure.

FIG. 3 is a schematic top view enlarging the raised portion 4a in the dotted line frame P of the decorative sheet shown in FIG. 2.

FIG. 4 is a schematic cross-sectional view exemplifying a decorative sheet in the present disclosure.

FIG. 5 is a schematic cross-sectional view exemplifying a decorative member in the present disclosure.

### DESCRIPTION OF EMBODIMENTS

Embodiments are hereinafter explained with reference to, for example, drawings. However, the present disclosure is implemented in a variety of different forms, and thus should not be taken as is limited to the contents described in the embodiments exemplified as below. Also, the drawings may show the features of the present disclosure such as width, thickness, and shape of each part schematically comparing to the actual form in order to explain the present disclosure more clearly in some cases; however, it is merely an example, and thus does not limit the interpretation of the present disclosure.

In the present descriptions, in expressing an aspect wherein some member is disposed on the other member, when described as merely “above” or “below”, unless otherwise stated, it includes both of the following cases: a case wherein some member is disposed directly on or directly below the other member so as to be in contact with the other member, and a case wherein some member is disposed on the upper side or the lower side of the other member via yet another member. Also, in the present descriptions, on the occasion of expressing an aspect wherein some member is disposed on the surface of the other member, when described as merely “on the surface”, unless otherwise stated, it includes both of the following cases: a case wherein some member is disposed directly on or directly below the other member so as to be in contact with the other member, and a case wherein some member is disposed on the upper side or the lower side of the other member via yet another member.

As described above, although a strong texture can be obtained by including beads with large particle size in the raised portion, the raised portion is highly glossy and it is difficult to express the appearance of natural materials such as natural wood, for example.

### A. Decorative Sheet

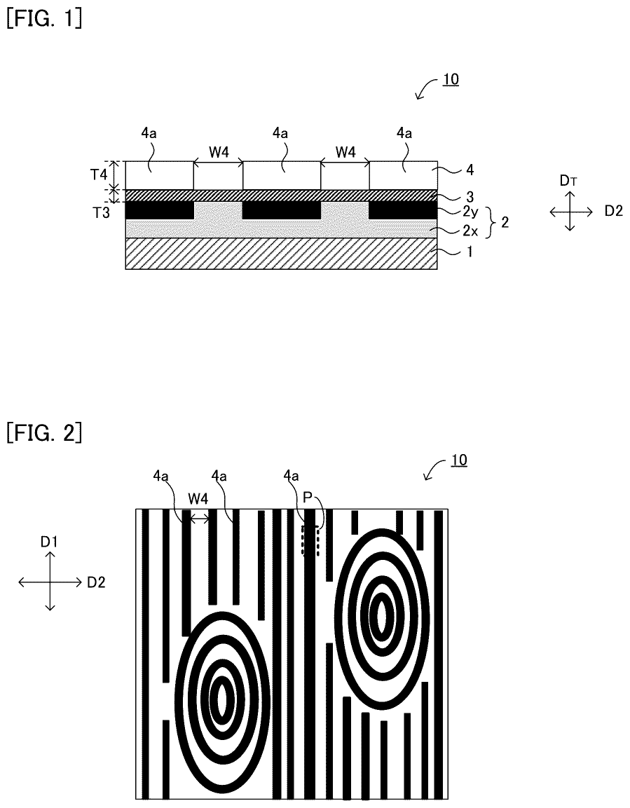

The decorative sheet in the present disclosure will be hereinafter described in detail. FIG. 1 is a schematic cross-sectional view exemplifying the decorative sheet of the present disclosure. The decorative sheet 10 shown in FIG. 1 comprises: a substrate layer 1; a design layer 2; a protective layer 3; and a raised layer 4 including a raised portion 4a formed in a pattern, in this order in a thickness direction Dr. In the present disclosure, the 60° gloss value of the protective layer 3 is less than the 60° gloss value of the raised layer 4; the 60° gloss value of the raised layer 4 is 20 or less; in the thickness direction D_{T}, the ratio of an area of the raised layer 4, with respect to an area of the protective layer 3, is 10% or more; and an average distance between adjacent raised portions 4a is 1.6 mm or more.

According to the present disclosure, when the average distance between adjacent raised portions 4a is a predetermined value or more, and the ratio of the area of the raised layer 4, with respect to the area of the protective layer 3, is a predetermined value or more, a strong rugged texture is obtained. Also, when the 60° gloss value of the protective layer 3 is less than the 60° gloss value of the raised layer 4; and the 60° gloss value of the raised layer 4 is a predetermined value or less, the gloss feeling of the raised layer can be reduced while maintaining the gloss matte feeling so that natural and authentic design can be obtained with a structure of smaller number of layers.

### 1. Raised Layer

As shown in FIG. 1, the raised layer 4 in the present disclosure is disposed on the surface of the protective layer 3 that is opposite side to the design layer 2, and includes raised portions 4a in a pattern. By being formed from a number of raised portions 4a provided on the protective layer 3, the raised layer 4 can improve the designability of the decorative sheet.

### (1) 60° Gloss

The 60° gloss value of the raised layer is more than the 60° gloss value of the protective layer, and is 20 or less. The 60° gloss value of the raised layer is preferably 15 or less, and more preferably 10 or less. When the 60° gloss value is in the above range, the gloss feeling of the raised layer can be reduced, and natural and authentic design can be obtained. Meanwhile, the 60° gloss value is, for example, 4 or more, and may be 6 or more. When the 60° gloss value is in the above range, the gloss feeling of the raised layer can be suppressed from being too low, and excellent gloss matte feeling can be maintained together with the protective layer.

In the present disclosure, the 60° gloss value of the raised layer is the value measured by the following method.

Disposing a decorative sheet so that the raised layer side is on the upper side, using a gloss meter and from the raised layer side, the specular glossiness at 60° of the raised layer is measured according to Method 3 of JIS Z 8741:1997. The 60° gloss value of the raised layer is an average value of the measured value at arbitrary 10 locations in the raised portion. At each measurement point, the measurement is carried out so that the raised portion is at the center of the measurement site of the gloss meter, and that 50% or more of the area of the measurement site overlaps with the raised portion. The center of the measurement site of the gloss meter is the center of the incident region where the light from the light source of the gloss meter enters.

The 60° gloss value of the raised layer can be adjusted by, for example, the type, the average particle size, and the content of the filler described later. For example, when inorganic particles are used as the filler, the gloss value tends to be reduced. When the average particle size of the inorganic particles is increased, the gloss value tends to be reduced. When the content of the inorganic particles is increased, the gloss value tends to be reduced. Although organic particles have less matting effect than the inorganic particles, when the content of the organic particles is increased, the gloss value tends to be reduced. Also, although the organic particles generally have larger average particle size than the inorganic particles, the 60° gloss value tends to be reduced by decreasing the average particle size.

### (2) Raised Portion

The raised layer includes a raised portion 4a formed in a pattern. The raised portion 4a is preferably disposed so that it is aligned with the pattern of the design layer 2. “Aligned with” means that the shape and position of the two patterns of interest roughly conform with each other. Specifically, the shape and position of the pattern of the raised portion 4a and at least a part of the pattern constituting the pictorial pattern of the design layer 2 match to the extent that they do not impair the sense of authenticity and luxury.

In FIG. 1, the design layer 2 includes the pattern layer 2y, and the raised portion 4a aligns with the pattern layer 2y. By arranging the raised portion 4a so as to align with the pattern of the design layer, the designability of the decorative sheet can be improved by the synergistic effect of the raised portion 4a and the pattern of the design layer. For example, in the case of a wood-grain pattern, the texture is improved by aligning the pattern of the raised portion 4a with the dark pattern such as the conduit. In the plan view of the decorative sheet, for example, when the total area of the pattern layer is regarded as 100, the area of the raised portion 4a aligned with the pattern layer is preferably 90 or more, more preferably 95 or more, further preferably 97 or more, and particularly preferably 99 or more. Meanwhile, the raised portion 4a may be disposed so that it is not aligned with the pattern of the design layer.

In the present disclosure, the average distance between adjacent raised portions 4a is usually 1.6 mm or more, preferably 2.0 mm or more, and more preferably 2.3 mm or more. When the average distance between adjacent raised portions 4a is less than the above range, strong texture cannot be obtained. Meanwhile, the average distance between adjacent raised portions 4a is, for example, 4.0 mm or less, and may be 3.0 mm or less.

In the present disclosure, the average distance between adjacent raised portions 4a is the average value of the values of 80 points obtained by measuring the distance W4 between the upper end portions of the adjacent raised portion 4a, at 100 points in the cross-sectional image of the decorative sheet, and excluding the minimum value to the tenth smallest value and the maximum value to the tenth largest value. For example, in FIG. 1 and FIG. 2, the average distance between adjacent raised portions 4a corresponds to the average distance between adjacent raised portions 4a in the vertical direction D2 with respect to the longitudinal direction D1 of the raised portions 4a. In particular, when the pattern of the design layer is a wood-grain pattern, the direction in which the conduit of the wood-grain extends coincides the longitudinal direction of the raised portion 4a. Also, for example, when the raised portion 4a does not have a specific longitudinal direction, such as a case where the pattern of the design layer is a stone-grain pattern, it corresponds to the average distance between adjacent raised portions 4a in multiple arbitrary directions, not limited to a specific direction.

The cross-sectional shape of the raised portion in the D2 direction is not particularly limited, and examples thereof may include an approximate rectangular shape, an approximate polygonal shape, and an approximate circular shape. In FIG. 4, the cross-sectional shape of the raised portion 4a is an approximate rectangular shape (trapezoidal shape).

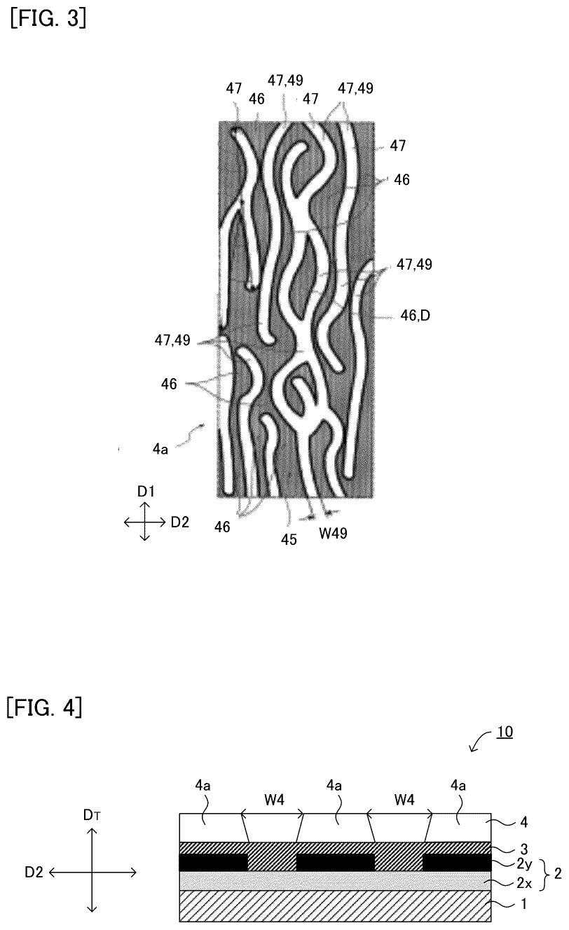

FIG. 3 shows a schematic top view enlarging the raised portion 4a in the dotted line frame P of the decorative sheet shown in FIG. 2. As shown in FIG. 3, one raised portion 4a may include irregular convexoconcave surfaces 45. Examples of such convexoconcave surface may include the convexoconcave surface of the raised portion described in the Japanese Patent Application Laid-Open (JP-A) No. 2022-55319. Specifically, the convexoconcave surface 45 includes the convex portion 46 and the concave portion 47. The convex portion 46 and concave portion 47 forming the irregular convexoconcave surface 45 may have irregularities in the arrangement. The convex portion 46 and concave portion 47 may have irregularities in shape. As shown in FIG. 3, the convexoconcave surface 45 of the raised portion 4a may have a wood-surface shape. As shown in FIG. 3, at least one of the convex portion 46 and concave portion 47 may be a linear portion 49 where at least one of the direction and length is not constant. Both of the convex portion 46 and concave portion 47 may be a linear portion 49 where at least one of the direction and length is not constant.

With the raised portion 4a, texture can be imparted by the level difference between the convex portion 46 and concave portion 47 at the internal region. In other words, the raised layer 4 can impart the texture not only at the rim portion of the raised portion 4a, but also can impart the texture at the internal portion of the raised portion 4a. Therefore, the convexoconcave of the surface of the decorative sheet 10 can be emphasized with stronger texture.

In addition, by eliminating the regularity of the convexoconcave surface 45, an artificial impression can be suppressed, when the convexoconcave surface 45 is observed. Therefore, it is possible to express the natural texture of the raised portion 4a and to improve the designability synergistically by combining it with the design layer.

The size of the linear portion 49 in the stretching direction is regarded as the total length of the linear portion 49. The size of the linear portion 49 in the direction perpendicular to the stretching direction is regarded as the width of the linear portion 49. The size of the linear portion 49 in D_{T} direction (the depth direction of the paper surface) is regarded as the depth of the linear portion 49.

In the decorative sheet 10 shown in FIG. 3, the convex portion 46 includes the convex portion D, whose entire circumference is surrounded by the concave portion 47 in a plan view. In a plan view, the convex portion D may be disposed irregularly at the internal region of the raised portion 4a. The planar shape of the convex portion D included in one raised portion 4a may be an indefinite shape but not a definite geometric shape such as triangle, tetragonal, circular or elliptical. The area of the convex portion D in a plan view may be irregularly different between a plurality of convex portions D. That is, the area of the plurality of convex portions D in a plan view may be different from each other.

The dimensions of the convex portion D in a plan view can be set in view of the realization of texture and natural feeling. The maximum dimension of the convex portion D along the D2 direction is preferably 30 μm or more and 500 μm or less, and more preferably 100 μm or more and 300 μm or less. The maximum dimension of the convex portion D along the D1 direction is preferably 40 μm or more and 20000 μm or less, and more preferably 400 μm or more and 8000 μm or less.

As shown in FIG. 3, the decorative sheet 10 may include the convex portion 46 wherein a part thereof is not surrounded by the concave portion 47, in addition to the convex portion D whose entire circumference is surrounded by the concave portion 47 in a plan view.

The length of the linear portion 49 is not particularly limited. The both edge of at least a part of the linear portion 49 may be located at the rim of the raised portion 4a. At least a part of the linear portion 49 may include one edge portion or the both edge portions located at the internal region of the raised portion 4a. That is, only one edge portion of the linear portion 49 may be located at the rim of the raised portion 4a. The both edge portions of the linear portion 49 may be located at the internal region of the raised portion 4a. These locations of the edge portions of the linear portion 49 may be different from each other among the linear portions 49 included in one raised portion 4a.

The width W49 of the linear portion 49 (refer FIG. 3) is not particularly limited. The width W49 of the linear portion 49 may be 50 μm or more and 250 μm or less. The width W49 may be different between the plurality of linear portions 49. The height difference of the line portions 49, that is, the height difference between the concave portion 47 and the convex portion 46 is the difference between the smallest (lowest) portion of the concave portion 47 and the largest (highest) portion of the convex portion 46 in the D_{T} direction (depth direction of the paper surface). The height difference is not particularly limited, and may be 10 μm or more and 200 μm or less. The height difference due to the plurality of linear portions 49 may be the same, and may be different from each other. The height difference due to one linear portion 49 may be constant, and may vary along the longitudinal direction of the corresponding linear portion 49.

The cross-sectional shape, at the cross-section orthogonal to the longitudinal direction of the linear portion 49, is not particularly limited. The cross-sectional shape, at the cross-section orthogonal to the longitudinal direction of the linear portion 49 can be any shape such as semi-circular, semi-elliptical, triangular, tetragonal, pentagonal, hexagonal, other polygonal, irregular geometric shapes.

### (3) Area

In the decorative sheet in the present disclosure, the ratio of the area of the raised layer, with respect to the area of the protective layer, in the thickness direction is usually 10% or more, preferably 20% or more, more preferably 30% or more, and particularly preferably 40% or more. In the present disclosure, when the average distance between adjacent raised portions 4a is a predetermined value or more, and the ratio of the area of the raised layer 4, with respect to the area of the protective layer 3, is a predetermined value or more, a strong rugged texture is obtained. Also, when the ratio of the area of the raised layer, with respect to the area of the protective layer is in the above range, wear resistance, scuff resistance and fouling resistance are improved. Meanwhile, the ratio of the area of the raised layer is, for example, 55% or less, and preferably 50% or less.

The ratio of the area of the raised layer, with respect to the area of the protective layer, in the thickness direction is the ratio of the area of the raised region provided with the raised layer, included in the measurement region with respect to the area of the region provided with the protective layer, included in the measurement region, viewed from the thickness direction, and is the calculated average value of the area ratio at 100 locations, setting the measurement region to a range of 10 mm×10 mm.

### (4) Thickness

With respect to the average thickness T3 of the protective layer, the average thickness T4 of the raised layer in the present disclosure is, for example, 2.0 times or more, may be 2.5 times or more, and may be 3.0 times or more. When the average thickness of the raised layer is in the above range, wear resistance, scuff resistance and fouling resistance are improved. The specific average thickness of the raised layer is, for example, 10 μm or more, may be 15 μm or more, and may be 20 μm or more. Meanwhile, the average thickness of the raised layer is, for example, 50 μm or less, may be 40 μm or less, and may be 30 μm or less.

The average thickness of the raised layer is the average values of the values at 80 locations, excluding 10 minimum values and 10 maximum values from 100 values obtained by measuring the thickness T4 of the raised portion 4a of the cross-section of the decorative sheet, from the image taken using a scanning electron microscope (SEM). When the raised portion includes a convexoconcave surface, the thickness is measured at the convex portion. Also, the same applies to the average thickness of the protective layer.

### (5) Composition

### (i) Filler

The raised portion preferably includes filler. That is, the raised layer preferably includes the filler. Examples of the filler may include organic particles and inorganic particles. Examples of the organic particles may include beads formed from resins such as acrylic resins, urethane resins, silicone resins, and polyamide resins such as nylon. Examples of the inorganic particles may include beads formed from inorganic materials such as silica, alumina, zirconia, titania (titanium dioxide), kaolinite, calcium carbonate, and barium sulfate. One type of the particles described above may be used alone, and two types or more may be used in a combination.

The average particle size of the inorganic particles is not particularly limited. The average particle size of the inorganic particles is, for example, 2 μm or more, may be 3 μm or more, and may be 5 μm or more. Meanwhile, the average particle size of the inorganic particles is, for example, 12 μm or less, and may be 10 μm or less. In the present specification, the average particle size is D50 in the volume-based particle size distribution measured by a laser diffraction scattering method.

The content of the inorganic particles in the raised portion may be 2 parts by mass or more, preferably 5 parts by mass or more, may be 15 parts by mass or more, and may be 18 parts by mass or more, with respect to 100 parts by mass of the resin components in the raised portion. Meanwhile, the content of the inorganic particles in the raised portion may be, for example, 38 parts by mass or less, may be 28 parts by mass or less, and may be 25 parts by mass or less.

The average particle size of the organic particles is not particularly limited. The average particle size of the organic particles is, for example, 20 μm or more, and may be 30 μm or more. Meanwhile, the average particle size of the organic particles is, for example, 60 μm or less, and may be 50 μm or less.

The content of the organic particle in the raised portion, with respect to 100 parts by mass of the resin components in the raised portion, is preferably 7 parts by mass or more, and may be 10 parts by mass or more. Meanwhile, the content of the organic particles in the raised portion may be, for example, 38 parts by mass or less, may be 33 parts by mass or less, and may be 25 parts by mass or less.

When the raised portion includes both of the organic particles and inorganic particles as the filler, the content of the organic particles with respect to the filler content in the raised portion is, for example, 20% by mass or more, may be 30% by mass or more, and may be 40% by mass or more. Meanwhile, the content of the organic particles is, for example, 80% by mass or less, may be 70% by mass or less, and may be 60% by mass or less.

When the raised portion includes both of the organic particles and inorganic particles as the filler, the content of the inorganic particles with respect to the filler content in the raised portion is, for example, 20% by mass or more, may be 30% by mass or more, and may be 40% by mass or more. Meanwhile, the content of the inorganic particles is, for example, 80% by mass or less, may be 70% by mass or less, and may be 60% by mass or less.

### (ii) Resin Component

The material constituting the raised portion includes a resin component. The resin component is typically a cured product (cross-linked structure) of a curable resin X. Meanwhile, the resin component may be thermoplastic resin. Particularly, the raised portion preferably includes a cured product of a curable resin X. The curable resin X may be, for example, at least one type selected from two-liquid curable resin, thermosetting resin and ionizing radiation curable resin.

Examples of the two-liquid curable resin may include two-liquid curable type urethane resins using a polyol compound as a main agent and isocyanate compound as a curing agent, two-liquid curable type epoxy resins, two-liquid curable type urethane modified acrylic resins, and two-liquid curable type polyester resins.

Examples of the thermosetting resin may include acrylic based resins, urethane based resins, phenolic based resins, melamine based resins, epoxy based resins, unsaturated polyester based resins, and silicone based resins.

The ionizing radiation curable resin is a composition including a compound including an ionizing radiation curable functional group. Examples of the ionizing radiation curable functional group may include ethylenically unsaturated bonding groups such as a (meth) acryloyl group, a vinyl group, and an allyl group; an epoxy group; and an oxetanyl group. The ionizing radiation curable resin may be a compound including an ethylenically unsaturated bonding group. The ionizing radiation curable resin may be a compound including two or more ethylenically unsaturated bonding groups, and preferably, it may be a polyfunctional (meth)acrylate based compound including two or more ethylenically unsaturated bonding groups. The polyfunctional (meth)acrylate based compound may be a monomer, and may be an oligomer. The ionizing radiation refers to, among electromagnetic waves and charged particle beams, one having energy quantum capable of polymerizing or cross-linking molecules. Examples of the ionizing radiation may include ultraviolet ray (UV), and electron beam (EB). The ionizing radiation may be electromagnetic waves such as X-rays and γ-rays; and charged particle beams such as α-rays and ion rays.

Among the polyfunctional (meth)acrylate based compound, examples of the bifunctional (meth)acrylate based monomer may include ethylene glycol di(meth)acrylate, bisphenol A tetraethoxydiacrylate, bisphenol A tetrapropoxydiacrylate, and 1,6-hexanediol diacrylate. Examples of the trifunctional or more functional (meth)acrylate based monomer may include trimethylolpropane tri(meth)acrylate, pentaerythritol tri(meth)acrylate, pentaerythritol tetra(meth)acrylate, dipentaerythritol hexa(meth)acrylate, dipentaerythritol tetra(meth)acrylate, and isocyanuric acid modified tri(meth)acrylate. A part of the molecular skeleton of the (meth)acrylate based monomers may be modified. The (meth)acrylate based monomers may be one modified by, for example, ethylene oxide, propylene oxide, caprolactone, isocyanuric acid, alkyl, cyclic alkyl, aromatic, or bisphenol.

Examples of the polyfunctional (meth)acrylate based oligomer may include acrylate based polymers such as urethane (meth)acrylate, epoxy (meth)acrylate, polyester (meth)acrylate and polyether (meth)acrylate. The urethane (meth)acrylate is obtained, for example, by the reaction of polyalcohols and organic diisocyanates with hydroxy (meth)acrylate. The epoxy (meth)acrylate may be (meth)acrylate obtained by reacting (meth)acrylic acid with tri or more functional aromatic epoxy resins, alicyclic epoxy resins, aliphatic epoxy resins; (meth)acrylate obtained by reacting (meth)acrylic acid with bi or more functional aromatic epoxy resins, alicyclic epoxy resins, aliphatic epoxy resins and polybasic acid; or (meth)acrylate obtained by reacting (meth)acrylic acid with bi or more functional aromatic epoxy resins, alicyclic epoxy resins, aliphatic epoxy resins and phenols. One type of the ionizing radiation curable resin may be used alone, and two types or more may be used in a combination.

When the ionizing radiation curable resin is an ultraviolet curable resin, the composition may include an additive such as a photopolymerization initiator and a photopolymerization accelerator. For a compound including the ethylenically unsaturated group, examples of the photopolymerization initiator may include one type or more selected from acetophenone, benzophenone, α-hydroxyalkylphenone, Michler's ketone, benzoin, benzyldimethylketol, benzoyl benzoate, α-acyloxime esters, and thioxanthones. The photopolymerization accelerator can reduce the inhibition of polymerization by air during curing and increase the curing speed. Examples of the photopolymerization accelerator may include one type or more selected from p-dimethylaminobenzoic acid isoamyl ester and p-dimethylaminobenzoic acid ethyl ester.

Examples of the thermoplastic resin may include acrylic based resins, cellulose based resins, urethane based resins, vinyl chloride based resins, polyester based resins, polyolefin based resins, polycarbonates, nylons, polystyrenes, and ABS resins.

The raised layer may be transparent, and may be colored. By adding a colorant (pigment or dye) to the composition, the material used for the raised layer may be colored. The colorant may be known or commercially available pigments or dyes. One type of the colorant may be used alone, and two types or more may be used in a combination. The content of the colorant is appropriately set according to, for example, the desired tint.

The raised layer may include various additives such as foaming agents, flame retardants, lubricants, antistatic agents, antioxidants, ultraviolet ray absorber, light stabilizers, radical scavengers and soft components (such as rubbers).

As for the method for forming the raised layer, the raised portion can be formed by, for example, coating the surface of the protective layer that is opposite side to the design layer with an ink for forming a raised layer including curable resin X, by a gravure printing using, for example, a plate mold or a grating, and curing thereof as necessary. When the raised portion includes a convexoconcave surface described above, for example, plates described in Japanese Patent Application Laid-Open (JP-A) No. 2022-55319 may be used.

When the ink for forming a raised layer includes an electron beam curable resin as the curable resin X, a cured product of the electron beam curable resin is usually obtained by irradiating an electron beam. Examples of the electron beam source may include various electron beam accelerators such as Cockcroft-Walton type, Van de Graaff type, resonant transformer type, insulated core transformer type, linear type, dynamitron type, and high frequency type. The energy of the electron beam is, for example, 100 kV or more and 1000 kV or less, and may be 100 kV or more and 300 kV or less. The irradiance level of the electron beam is, for example, 2 Mrad or more and 15 Mrad or less.

When the ink for forming a raised layer includes an ultraviolet ray curable resin as the curable resin X, a cured product of the ultraviolet ray curable resin is usually obtained by irradiating ultraviolet rays. Examples of the ultraviolet ray source may include an ultra-high pressure mercury lamp, a high pressure mercury lamp, a low pressure mercury lamp, a carbon arc lamp, a black light fluorescent lamp, and a metal halide lamp. The wavelength of the ultraviolet ray is, for example, 190 nm or more and 380 nm or less.

When the ink for forming a raised layer includes a thermosetting resin as the curable resin X, a cured product of the thermosetting resin is usually obtained by heating. The heating temperature is appropriately set according to the type of the thermosetting resin. The ink for forming a raised layer may include curing agents such as cross-linking agents and polymerization initiators, and polymerization accelerators, together with the thermosetting resin. Examples of the curing agent may include isocyanates, organosulfonates, organoamines, peroxides (such as methyl ethyl ketone peroxide), and radical initiators (azoisobutyl nitrile).

The ink for forming a raised layer may include solvents as necessary. Examples of the solvent may include water; hydrocarbon compounds such as toluene and xylene; alcoholic compounds such as methanol, ethanol, methyl glycol; ketone compounds such as acetone and methyl ethyl ketone; ester compounds such as methyl formate, ethyl acetate and butyl acetate; nitrogen containing compounds such as N-methylpyrrolidone, N,N-dimethylformamide; ether compounds such as tetrahydrofuran and dioxane; halogenated hydrocarbon compounds such as methylene chloride and chloroform; and dimethylsulfoxide.

### 2. Protective Layer

As shown in FIG. 1, the protective layer 3 in the present disclosure is disposed between the design layer 2 and raised layer 4. The protective layer in the present disclosure may be disposed partially, and may be disposed on the entire surface, with respect to the substrate layer described later. Among them, the protective layer is preferably disposed over the entire surface of the substrate layer. Also, as shown in FIG. 1, the protective layer 3 is preferably in direct contact with the raised layer 4. In the decorative sheet in the present disclosure, a natural and authentic design can be obtained with a few layer structures.

The 60° gloss value of the protective layer in the present disclosure is not particularly limited as long as it is less than the 60° gloss value of the raised layer, and is, for example, 3 or less and may be 2 or less. Meanwhile the 60° gloss value of the protective layer is, for example, 1 or more.

The material of the protective layer is not particularly limited as long as it protects the design layer and has a predetermined 60° gloss value. The material constituting the protective layer includes, for example, a resin component. Examples of the resin component may include types similar to the resin component exemplified for the raised layer described above.

The protective layer includes, for example, a matting agent. Examples of the matting agent may include types similar to the inorganic particles exemplified for the raised layer described above. The average particle size of the inorganic particles used for the protective layer is, for example, 1 μm or more, may be 3 μm or more, and may be 5 μm or more. Meanwhile, the average particle size of the inorganic particles used for the protective layer is, for example, 20 μm or less, and may be 15 μm or less.

The content of the inorganic particles in the protective layer, with respect to 100 parts by mass of the resin components in the protective layer, is preferably 10 parts by mass or more and may be 20 parts by mass or more. Meanwhile, the content of the inorganic particles in the protective layer may be, for example, 40 parts by mass or less, and may be 30 parts by mass or less.

The average thickness of the protective layer is not particularly limited, and is, for example, 1 μm or more, and preferably 5 μm or more. When the average thickness of the protective layer is in the above range, wear resistance, scuff resistance and cellophane tape resistance are improved. Meanwhile, the average thickness of the protective layer is, for example, 50 μm or less, may be 30 μm or less, and may be 20 μm or less. When the thickness of the protective layer is in the above range, for example, when the protective layer includes silica, the increase of cloudiness caused by silica can be suppressed, and the visibility of the design layer is improved. Further, the protective layer is suppressed from being too hard, so that, when it is folded, surface cracking can be suppressed.

### 3. Design Layer

The design layer in the present disclosure is disposed between the substrate layer and the protective layer. The design layer preferably includes a pattern.

Examples of the pattern of the design layer may include organic patterns, inorganic patterns and abstract patterns. An organic pattern refers to a pattern derived from the life activities of living organisms such as animals and plants. Also, inorganic pattern refers to a pattern that does not correspond to the organic pattern. Also, an abstract pattern refers to a pattern that interprets an object (for example, a figure that exists in the natural world) in an abstract manner, and does not express an obvious shape. Examples of the organic pattern may include wood-grain pattern, leather pattern, floral pattern, and botanical pattern. Examples of the inorganic pattern may include stone-grain pattern, concrete pattern, sand-grain pattern, fabric-grain pattern, metal pattern, tiling pattern, and brick pattern. Examples of the abstract pattern may include flickering pattern (for example, flickering ink pattern), smoke pattern, and marble pattern.

The design layer includes, for example, a pictorial pattern layer. Also, the design layer may include a solid layer on the substrate layer side than the pattern layer. In the present disclosure, the patter layer means a layer formed partially (especially in a pattern) on one surface of the substrate layer. Also, the solid layer means a layer formed over the entire surface of one surface of the substrate layer.

The design layer includes, for example, a colorant and a resin component. Examples of the colorant may include inorganic pigments such as carbon black, titanium white, zinc flower, Bengal red, ultramarine blue, cadmium red; organic pigments such as azo pigment, rake pigment, anthraquinone pigment, quinaclidone pigment, phthalocyanine pigment, isoindrinone pigment, dioxadine pigment; metal powder pigments such as aluminum powder and bronze powder; pearlescent pigments such as titanium oxide-coated mica and bismuth oxychloride; fluorescent pigments; and luminous pigments. Dyes may be used as the colorant.

Examples of the resin component may include (meth)acrylic based resins, ester urethane based resins, acrylamide based resins, ethylene oxide based resins, N-vinylpyrrolidone based resins, ester based resins, amide based resins, vinyl acetate based resins, vinyl chloride based resins, urethane (meth)acrylic based resins, natural rubbers, synthetic rubbers, and cellulose derivatives. Among them, (meth)acrylic based resins, and urethane (meth)acrylic based resins are preferable.

The design layer may include additives, such as fillers (such as silica), extender pigments (such as organic beads), neutralizers, and surfactants, if necessary. The thickness of the design layer is not particularly limited, and it is, for example, 0.1 μm or more and 20 μm or less.

Examples of the method for forming a design layer may include applying methods using an ink for forming a design layer including a colorant, a binder resin, and a solvent (or a dispersant). For example, a design layer is obtained by coating one surface of a substrate layer with the ink for forming a design layer, and drying.

Examples of the solvent (or dispersant) may include petroleum based organic solvents such as hexane, heptane, octane, toluene, xylene, ethylbenzene, cyclohexane, and methylcyclohexane; ester based organic solvent such as ethyl acetate, butyl acetate, 2-methoxyethyl acetate, and 2-ethoxyethyl acetate; alcoholic based organic solvents such as methyl alcohol, ethyl alcohol, normal propyl alcohol, isopropyl alcohol, isobutyl alcohol, ethylene glycol, and propylene glycol; ketone base organic solvents such as acetone, methyl ethyl ketone, methyl isobutyl ketone, and cyclohexanone; ether based organic solvents such as diethyl ether, dioxane, and tetrahydrofuran; chloride based organic solvents such as dichloromethane, carbon tetrachloride, trichloro ethylene, and tetrachloro ethylene; and inorganic solvents such as water.

Examples of the method for application may include printing methods. Examples of the printing method may include gravure printing method, offset printing method, screen printing method, flexographic printing method, electrostatic printing method, and inkjet printing method. Also, examples of the coating method for forming the solid layer may include various coating methods such as roll coating method, knife coating method, air knife coating method, die coating method, lip coating method, comma coating method, kiss coating method, flow coating method, and dip coating method.

### 4. Substrate Layer

The decorative sheet in the present disclosure includes a substrate layer. The substrate layer is a member configured to support the design layer, protective layer, and raised layer. Since the decorative sheet includes the substrate layer, various performance such as mechanical strength, post-processing suitability, and designability are improved so that usability as a sheet is improved.

The substrate layer is not particularly limited; and examples thereof may include a resin substrate, a glass substrate, a metal substrate, and fiber substrate. The type of the substrate layer is appropriately selected according to the use application of the decorative sheet.

Examples of the resin used for the resin substrate may include various synthetic resins, and various natural resins. Examples of the synthetic resin may include thermoplastic resins and curable resins. The thermoplastic resins are preferable in view of the production suitability, handling suitability and post-processing suitability of the decorative sheet.

Examples of the thermoplastic resin may include olefin resins such as polyethylene, polypropylene, polymethylpentene, ionomer, and various olefin based thermoplastic elastomers; vinyl chloride resins such as polyvinyl chloride, polyvinylidene chloride, and vinyl chloride-vinyl acetate copolymer; polyester resins such as polyethylene terephthalate, polybutylene terephthalate, polyethylene naphthalate, ethylene glycol-terephthalic acid-isophthalic acid copolymer, and polyester based thermoplastic elastomer; acrylic resins such as poly(meth)acrylic acid methyl, poly(meth)acrylic acid ethyl, poly(meth)acrylic acid butyl, and (meth)acrylic acid methyl-(meth)acrylic acid butyl copolymer; polyamide resins represented by nylon 6, and nylon 66; cellulose resins such as triacetyl cellulose, cellophane, and celluloid; styrene resins such as polystyrene, acrylonitrile-styrene copolymer, and acrylonitrile-butadiene-styrene copolymer (ABS resin); polyvinyl alcohols; ethylene-vinyl acetate copolymers; ethylene-vinylalcohol copolymers; polycarbonate resins; polyarylate resins; and polyimide resins.

Also, examples of the curable resin may include ionizing radiation curable resins and thermosetting resins.

Examples of the natural resin may include natural rubber, pine resin, and amber.

Examples of the metal used for the metal substrate may include aluminum alloys such as aluminum or duralumin; iron alloys such as iron or carbon steel, stainless steel; copper alloys such as copper or brass and bronze; gold; silver; chromium; nickel; cobalt; tin; and titanium. The metal substrate may include a plating film or an anodic oxide film on the surface.

Examples of the fiber materials used for the resin substrate may include paper such as thin-leaf paper, kraft paper, fine paper, Japanese paper, titanium paper, linter paper, sulfuric acid paper, paraffin paper, parchment paper, glassine paper, wallpaper backing paper, paperboard and base paper for plasterboard; and woven or nonwoven fabric including fibers such as polyester resin fibers, acrylic resin fibers, protein or cellulose based natural fibers such as silk, cotton and hemp, glass fibers, and carbon fibers. Various resins such as acrylic resins, styrene-butadiene rubbers, melamine resins, and urethane resins may be added to the fiber substrate. When the fiber substrate is a paper substrate, the strength between the fibers of the paper substrate or the interlayer strength between the paper substrate and other substrates can be improved. Also, fluffing can be suppressed. As for the method for adding the resin, an impregnation with resin may be carried out after papermaking, and a filling with resin may be carried out during papermaking. Examples of the paper substrate to which resins are added may include interpaper-reinforced paper, and resin-impregnated paper.

The substrate layer may include additives as necessary. In case of the resin substrate, examples of the additive may include inorganic fillers, flame retardants, lubricants, foaming agents, antioxidants, ultraviolet absorbers, light stabilizers and colorants. Various additives may be used alone, and a plurality types may be used in a combination. The content of the additives is not particularly limited as long as the surface properties or processing properties are not deteriorated, and may be appropriately set according to the required properties.

The substrate layer may be a single layer, and may be a stacked body of two layers or more. In a case of a stacked body, the substrate layer may include two or more layers of the same type of substrate, and may include two or more layers of different types of substrates.

The substrate layer may be transparent, and may be opaque.

Also, the substrate layer may be colored. The mode of the coloring is not particularly limited; and it can be transparent and colored, and may be opaque and colored (hiding and colored), and these can be chosen arbitrarily.

When the substrate layer is colored, it may include a colorant. Examples of the colorant may include inorganic pigments such as white pigments such as titanium white, iron black, lead yellow, titanium yellow, Bengal red, cadmium red, ultramarine blue, and cobalt blue; organic pigments or dyes such as quinacridone red, isoindolinone yellow, phthalocyanine blue, nickel-azo complex, azomethine azo based black pigment, and perylene based black pigment; metallic pigments including scaly foil pieces such as aluminum and brass; and pearlescent (pearl) pigments including scaly foil pieces such as titanium dioxide-coated mica, and basic lead carbonate. For example, when the surface hue of the adherent to which the decorative sheet is stacked is not uniform, when the surface hue is to be concealed and the color tone stability of the decorative layer is to be improved, inorganic pigments such as white pigments can be used.

In order to improve the close adhesiveness to the layer in contact with the substrate layer, for example, the close adhesiveness to the decorative layer, or the close adhesiveness to the adhesive layer, the substrate layer may be subjected to a surface treatment. Examples of the surface treatment may include physical surface treatments such as an oxidation method and a roughening method; and chemical surface treatment. Examples of the oxidation method may include corona discharge treatment, chromium oxidation treatment, flame treatment, hot air treatment, and ozone-ultraviolet treatment method. Examples of the roughening method may include a sand blasting method and a solvent treatment method. These surface treatments are appropriately selected according to the type of the substrate layer, and in general, corona discharge treatment is preferable in view of the effect of surface treatment and operability.

Also, when the substrate layer is a stacked body, in order to improve the close adhesiveness of each adjacent layer, an adhesive layer or a primer layer may be disposed between each layer.

The thickness of the substrate layer is not specifically limited, and is appropriately selected according to the material of the substrate layer. When the substrate layer includes resin, the thickness of the substrate layer is, for example, 10 μm or more and 300 μm or less, may be 20 μm or more and 200 μm or less, and may be 40 μm or more and 100 μm or less. Also, when the substrate layer is a paper substrate, the basis weight is, for example, 20 g/m² or more and 150 g/m² or less, and may be 30 g/m² or more and 100 g/m² or less.

### 5. Other Layers

As shown in FIG. 1, the decorative sheet in the present disclosure includes at least a substrate layer 1, a design layer 2, a protective layer 3, and a raised layer 4. Meanwhile, the decorative sheet in the present disclosure may include other layers in addition to these layers. Examples of the other layer may include a transparent resin layer, an adhesive layer, a separator layer, and a primer layer.

### (1) Transparent Resin Layer

The decorative sheet in the present disclosure may include a transparent resin layer between the protective layer and the design layer. By the transparent resin layer, the strength of the decorative sheet may be improved.

The transparent resin layer has only to be transparent to the extent that the design layer is visible, and it may be colorless and transparent, may be colored and transparent, and may be translucent.

Examples of the resin constituting the transparent resin layer may include polyolefin based resins, polyester resins, polycarbonate resins, acrylonitrile-butadiene-styrene resins (hereinafter, may be referred to as “ABS resins”), acrylic resins, and vinyl chloride resins. Among them, in view of processability, polyolefin based resin and vinyl chloride resins are preferred. One type of the resin may be used alone, and two types or more may be used in a combination.

The transparent resin layer may include an additive if necessary. Examples of the additive may include weather resistant agents such as ultraviolet absorbers and light stabilizers. The weather resistant agent can be appropriately selected from those described above and used.

In view of processability, the thickness of the transparent resin layer is, for example, 20 μm or more and 150 μm or less, may be 40 μm or more and 120 μm or less, and may be 60 μm or more and 100 μm or less.

Examples of a method for forming a transparent resin layer may include a method wherein a resin composition is applied; and a method wherein a resin film is stacked by a dry lamination.

### (2) Rear Surface Adhesive Layer

The decorative sheet in the present disclosure may include a rear surface adhesive layer on the surface of the substrate layer that is opposite side to the design layer. The rear surface adhesive layer is a member configured to adhere the decorative sheet to the adherend.

The rear surface adhesive layer may be transparent, and may be opaque.

Examples of the adhesive used for the rear surface adhesive layer may include curable type adhesives and pressure-sensitive type adhesives. Specific examples may include urethane based adhesives, acrylic based adhesives, epoxy based adhesives, and rubber based adhesives. Also, OCA (Optical Clear Adhesive) or OCR (Optical Clear Resin) can be used as the rear surface adhesive layer.

In view of obtaining a desired adhesiveness effectively, the thickness of the rear surface adhesive layer is, for example, 5 μm or more and 100 μm or less, may be 10 μm or more and 75 μm or less, and may be 20 μm or more and 50 μm or less.

Examples of a method for forming a rear surface adhesive layer may include a method wherein an adhesive composition is applied; and a method wherein an adhesive film is stacked by a dry lamination.

### (3) Primer Layer

In order to improve the close adhesiveness between multiple layers constituting the decorative sheet, the decorative sheet in the present disclosure may include a primer layer. The primer layer may be disposed between any layers.

The primer layer mainly includes binder resins, and may include an additive such as an ultraviolet absorber, and a light stabilizer, if necessary.

Examples of the binder resin may include urethane resins, acrylic polyol resins, acrylic resins, ester resins, amide resins, butyral resins, styrene resins, urethane-acrylic copolymers, polycarbonate based urethane-acrylic copolymers (urethane-acrylic copolymers deriving from polymers (polycarbonate polyol) including a carbonate bond on the main chain of the polymer, and including 2 or more hydroxy groups on the terminal and side chain), vinyl chloride-vinyl acetate copolymer resins, vinyl chloride-vinyl acetate-acrylic copolymer resins, chlorinated propylene resins, nitrocellulose resins (cellulose nitrate), and cellulose acetate resins. These may be used alone, and multiple types may be used in a combination.

Also, the binder resin may be resin obtained by cross-link curing the resins described above by adding a curing agent such as isocyanate based curing agents and epoxy based curing agents. For example, resin obtained by cross-link curing polyol based resins such as acrylic polyol resins with an isocyanate based curing agent is preferable, and resin obtained by cross-link curing acrylic polyol resins with an isocyanate based curing agent is more preferable.

The thickness of the primer layer is, for example, 0.5 μm or more, may be 1 μm or more, and may be 2 μm or more. Also, the thickness of the primer layer is, for example, 10 μm or less, may be 8 μm or less, and may be 6 μm or less.

Examples of a method for forming a primer layer may include a method wherein a resin composition is applied, dried if necessary and cured.

### (4) Separator Layer

The decorative sheet in the present disclosure may include a separator layer on the surface of the rear surface adhesive layer that is opposite side to the substrate layer. The separator layer is a member configured to protect the rear surface adhesive layer, and is peeled off when the decorative sheet is adhered to the adherent. As the separator layer, conventional commonly known ones can be used.

### B. Decorative Member

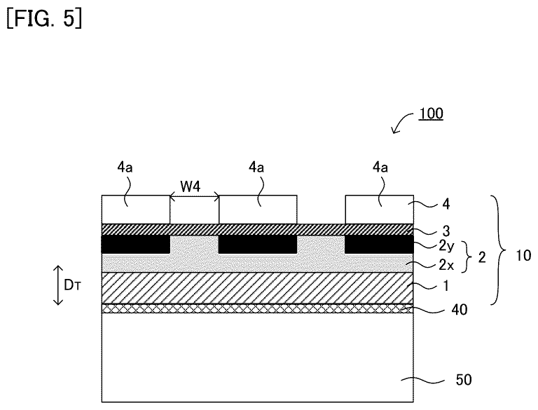

The decorative member in the present disclosure includes a base member, and the decorative sheet described above. FIG. 5 is a schematic cross-sectional view exemplifying the decorative member in the present disclosure. The decorative member 100 shown in FIG. 5 includes a base member 50, an adhesive layer 40, and the decorative sheet 10 described above, in this order. As shown in FIG. 5, the raised layer 4 of the decorative sheet 10 constitutes the outermost layer of the decorative member 100. The decorative sheet 10 is disposed so that the substrate layer 1 side surface faces the base member 50 side.

According to the present disclosure, since the decorative sheet described above is included, a decorative member having an authentic feeling while having a strong texture may be obtained.

### 1. Decorative Sheet

Since the decorative sheet in the present disclosure is similar to the contents described in “A. Decorative sheet” above, the description herein is omitted.

### 2. Base Member

The base member in the present disclosure is a member decorated by the decorative sheet. Examples of the base member may include a resin member. Examples of the resin used for the resin member may include vinyl chloride based resins, acrylic based resins, ester based resins, styrene based resins, olefin based resins, acrylonitrile-butadiene-styrene based copolymers (ABS based resins), phenolic based resins, cellulose based resins and rubber. Also, other examples of the base member may include a woody member. Examples of the woody member may include wood single panel, plywood panel, particle board, and woody fiberboard. Examples of the wood used for the woody member may include cedar, hinoki cypress, pine, and lauan.

Also, other examples of the base member may include a metal member. Examples of the metal used for the metal member may include iron, iron alloys (such as carbon steel, stainless steel), and aluminum. Also, other examples of the base member may include a ceramic member. The material of the ceramic member may be ceramics such as glass and pottery, may be non-cement ceramic materials such as gypsum, and may be non-pottery ceramic materials such as ALC (lightweight aerated concrete).

The shape of the base member is not particularly limited, and examples may include a plate shape, a sheet shape, and a tridimensional shape. Also, the base member may include a flat surface portion, may include a curved surface portion, and may include both the flat surface portion and the curved surface portion. Also, the base member may include at least one of a convex portion, a concave portion, a convexity portion, a concavity portion, and a through portion.

### 3. Adhesive Layer

The decorative member in the present disclosure may include an adhesive layer (second adhesive layer) between the base member and the decorative sheet. As the second adhesive layer disposed between the base member and the decorative sheet, for example, resins similar to the rear surface adhesive layer described above, is used. Also, when the decorative sheet includes the rear surface adhesive layer described above, the decorative sheet and the base member may be in direct contact with each other.

### 4. Decorative Member

The decorative member in the present disclosure includes the decorative sheet and the base member described above. The use application of the decorative member in the present disclosure is not particularly limited, and examples thereof may include construction members such as walls, ceilings, floors, roofs, eaves, fences and doors; fittings or fixture materials such as window frames, doors, railings, skirting boards, cornices, and malls; general furniture such as chest of drawers, shelves, and desks; kitchen furniture such as tables, and sinks; various furniture used with plumbing components such as kitchens, toilettes, bath rooms, and washstands; surface decorative plates of cabinets such as home electrical appliances and OA devices; and interior or exterior members for vehicles. Also, the decorative member in the present disclosure may be a member used outdoors (exterior member), and may be a member used indoors (interior member).

The decorative member in the present disclosure may be obtained by, for example, stacking the decorative sheet and the base member. Specifically, the surface of the base member (the surface to be decorated) and the substrate layer side surface of the decorative sheet are stacked so as to face each other.

Examples of the method for producing a decorative member may include a method wherein the decorative sheet in the present disclosure is adhered to the base member so that the rear surface adhesive layer of the decorative sheet and the surface of the base member are in direct contact. Also, other examples of the method for producing a decorative member may include a method wherein the decorative sheet in the present disclosure is stacked on the base member via the second adhesive layer so that the substrate layer side surface of the decorative sheet and the surface of the base member face each other.

Examples of the method for stacking the base member and the decorative sheet may include lamination method, wrapping method, and vacuum forming method. In the lamination method, for example, the decorative sheet is pressurized onto a plate-like base member with a pressuring roller. In the wrapping method, for example, while feeding the decorative sheet, the decorative sheet is sequentially pressurized and adhered to the multiple side surfaces constituting the base member, using multiple rollers with different orientations. When a hot melt adhesive (heat-sensitive adhesive) is used to stack the decorative sheet and the base member, the heating temperature at that time is, for example, 150° C. or more and 200° C. or less. Also, when a reactive hot melt adhesive is used, the heating temperature is, for example, 100° C. or more and 130° C. or less.

The present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

### Example 1

### (Production of Decorative Sheet)

As a substrate, colored base paper for construction materials (“CHPS 45 (model number)”, basis weight: 45 g/m² from Tentok Corporation) was prepared. A solid layer having a thickness of 5 μm was formed by coating one surface of the substrate with a resin composition including an acrylic resin as a binder, titanium white, Bengal red and lead yellow as colorants, by gravure printing method. Then, a pattern layer with a wood-grain pattern was formed on the solid layer by using a resin composition including cellulose nitrate as a binder and a colorant including Bengal red as a main component. Thereby, a design layer including the solid layer and pattern layer was formed on the substrate. Then, a protective layer having an average thickness of 5 μm was formed by coating the entire surface of the design layer with an ink for a protective layer including a two-liquid curable resin (main agent: acrylic polyol, curing agent: hexamethylene diisocyanate) and a matting agent (silica particles having an average particle size of 2 μm, 23 parts by mass with respect to 100 parts by mass of the resin components in the protective layer), and drying. Then, a raised layer including a plurality of raised portions was formed by coating a part of the protective layer with an ink for a raised layer 1 having the following formula, and drying. After that, a decorative sheet in Example 1 was obtained by heating and curing at 70° C. for 24 hours. Incidentally, the raised portion was formed so that the ratio of the area of the raised layer with respect to the area of the protective layer in the thickness direction, the average distance between adjacent raised portions, and the average thickness T4 of the raised layer were the values shown in Table 1.

### <Ink for Raised Layer 1>

Two-liquid curable resin 100 parts by mass (main agent: acrylic polyol, curing agent: hexamethylene diisocyanate)
Organic particles 33 parts by mass (spherical urethane beads, average particle size of 50 μm)
Solvent appropriate quantities (butyl acetate, ethyl acetate)

### Example 2

### (Production of Decorative Sheet)

As a substrate, colored base paper for construction materials (“CHPS 45 (model number)”, basis weight: 45 g/m² from Tentok Corporation) was prepared. A solid layer having a thickness of 5 μm was formed by coating one surface of the substrate with a resin composition including an acrylic resin as a binder, titanium white, Bengal red and lead yellow as colorants, by gravure printing method. Then, a pattern layer with a wood-grain pattern was formed on the solid layer by using a resin composition including cellulose nitrate as a binder and a colorant including Bengal red as a main component. Thereby, a design layer including the solid layer and pattern layer was formed on the substrate. Then, a protective layer having an average thickness of 5 μm was formed by coating the entire surface of the design layer with an ink for a protective layer including a two-liquid curable resin (main agent: acrylic polyol, curing agent; hexamethylene diisocyanate) and a matting agent (silica particles having an average particle size of 2 μm, 23 parts by mass with respect to 100 parts by mass of the resin components in the protective layer), and drying. Then, a raised layer including a plurality of raised portions was formed by coating a part of the protective layer with an ink for a raised layer 2 having the following formula, and drying. After that, a decorative sheet in Example 2 was obtained by heating and curing at 70° C. for 24 hours. Incidentally, the raised portion was formed so that the ratio of the area of the raised layer with respect to the area of the protective layer in the thickness direction, the average distance between adjacent raised portions, and the average thickness T4 of the raised layer were the values shown in Table 1.

### <Ink for Raised Layer 2>

Two-liquid curable resin 100 parts by mass (main agent: acrylic polyol, curing agent: hexamethylene diisocyanate)
Organic particles 11 parts by mass (spherical polymethyl methacrylate particles, average particle size of 50 μm)
Inorganic particles 9 parts by mass (silica particles, average particle size of 3 μm)
Solvent appropriate quantities (butyl acetate, ethyl acetate)

### Example 3

### (Production of Decorative Sheet)

As a substrate, colored base paper for construction materials (“CHPS 45 (model number)”, basis weight: 45 g/m² from Tentok Corporation) was prepared. A solid layer having a thickness of 5 μm was formed by coating one surface of the substrate with a resin composition including an acrylic resin as a binder, titanium white, Bengal red and lead yellow as colorants, by gravure printing method. Then, a pattern layer with a wood-grain pattern was formed on the solid layer by using a resin composition including cellulose nitrate as a binder and a colorant including Bengal red as a main component. Thereby, a design layer including the solid layer and pattern layer was formed on the substrate. Then, a protective layer having an average thickness of 5 μm was formed by coating the entire surface of the design layer with an ink for a protective layer including a two-liquid curable resin (main agent: acrylic polyol, curing agent: hexamethylene diisocyanate) and a matting agent (silica particles having an average particle size of 2 μm, 23 parts by mass with respect to 100 parts by mass of the resin components in the protective layer), and drying. Then, a raised layer including a plurality of raised portions was formed by coating a part of the protective layer with an ink for a raised layer 3 having the following formula, and drying. After that, a decorative sheet in Example 3 was obtained by heating and curing at 70° C. for 24 hours. Incidentally, the raised portion was formed so that the ratio of the area of the raised layer with respect to the area of the protective layer in the thickness direction, the average distance between adjacent raised portions, and the average thickness T4 of the raised layer were the values shown in Table 1.

### <Ink for Raised Layer 3>

Two-liquid curable resin 100 parts by mass (main agent: acrylic polyol, curing agent: hexamethylene diisocyanate)
Organic particles 11 parts by mass (spherical polymethyl methacrylate particles, average particle size of 50 μm)
Inorganic particles 4.5 parts by mass (silica particles, average particle size of 12 μm)
Solvent appropriate quantities (butyl acetate, ethyl acetate)

### Example 4

### (Production of Decorative Sheet)

As a substrate, colored base paper for construction materials (“CHPS 45 (model number)”, basis weight: 45 g/m² from Tentok Corporation) was prepared. A solid layer having a thickness of 5 μm was formed by coating one surface of the substrate with a resin composition including an acrylic resin as a binder, titanium white, Bengal red and lead yellow as colorants, by gravure printing method. Then, a pattern layer with a wood-grain pattern was formed on the solid layer by using a resin composition including cellulose nitrate as a binder and a colorant including Bengal red as a main component. Thereby, a design layer including the solid layer and pattern layer was formed on the substrate. Then, a protective layer having an average thickness of 5 μm was formed by coating the entire surface of the design layer with an ink for a protective layer including a two-liquid curable resin (main agent: acrylic polyol, curing agent: hexamethylene diisocyanate) and a matting agent (silica particles having an average particle size of 2 μm, 23 parts by mass with respect to 100 parts by mass of the resin components in the protective layer), and drying. Then, a raised layer including a plurality of raised portions was formed by coating a part of the protective layer with an ink for a raised layer 4 having the following formula, and drying. After that, a decorative sheet in Example 4 was obtained by heating and curing at 70° C. for 24 hours. Incidentally, the raised portion was formed so that the ratio of the area of the raised layer with respect to the area of the protective layer in the thickness direction, the average distance between adjacent raised portions, and the average thickness T4 of the raised layer were the values shown in Table 1.

### <Ink for Raised Layer 4>

Two-liquid curable resin 100 parts by mass (main agent: acrylic polyol, curing agent: hexamethylene diisocyanate)
Inorganic particles 28 parts by mass (silica particles, average particle size of 3 μm)
Solvent appropriate quantities (butyl acetate, ethyl acetate)

### Example 5

### (Production of Decorative Sheet)

As a substrate, colored base paper for construction materials (“CHPS 45 (model number)”, basis weight: 45 g/m² from Tentok Corporation) was prepared. A solid layer having a thickness of 5 μm was formed by coating one surface of the substrate with a resin composition including an acrylic resin as a binder, titanium white, Bengal red and lead yellow as colorants, by gravure printing method. Then, a pattern layer with a wood-grain pattern was formed on the solid layer by using a resin composition including cellulose nitrate as a binder and a colorant including Bengal red as a main component. Thereby, a design layer including the solid layer and pattern layer was formed on the substrate. Then, a protective layer having an average thickness of 8 μm was formed by coating the entire surface of the design layer with an ink for a protective layer including a two-liquid curable resin (main agent: acrylic polyol, curing agent; hexamethylene diisocyanate) and a matting agent (silica particles having an average particle size of 2 μm, 23 parts by mass with respect to 100 parts by mass of the resin components in the protective layer), and drying. Then, a raised layer including a plurality of raised portions was formed by coating a part of the protective layer with an ink for a raised layer 5 having the following formula, and drying. After that, a decorative sheet in Example 5 was obtained by heating and curing at 70° C. for 24 hours. Incidentally, the raised portion was formed so that the ratio of the area of the raised layer with respect to the area of the protective layer in the thickness direction, the average distance between adjacent raised portions, and the average thickness T4 of the raised layer were the values shown in Table 1.

### <Ink for Raised Layer 5>

Two-liquid curable resin 100 parts by mass (main agent: acrylic polyol, curing agent: hexamethylene diisocyanate)
Organic particles 7.6 parts by mass (spherical polymethyl methacrylate particles, average particle size of 50 μm)
Inorganic particles 15 parts by mass (silica particles, average particle size of 6 μm)
Solvent appropriate quantities (butyl acetate, ethyl acetate)

### Example 6

### (Production of Decorative Sheet)

As a substrate, colored base paper for construction materials (“CHPS 45 (model number)”, basis weight: 45 g/m² from Tentok Corporation) was prepared. A solid layer having a thickness of 5 μm was formed by coating one surface of the substrate with a resin composition including an acrylic resin as a binder, titanium white, Bengal red and lead yellow as colorants, by gravure printing method. Then, a pattern layer with a wood-grain pattern was formed on the solid layer by using a resin composition including cellulose nitrate as a binder and a colorant including Bengal red as a main component. Thereby, a design layer including the solid layer and pattern layer was formed on the substrate. Then, a protective layer having an average thickness of 1 μm was formed by coating the entire surface of the design layer with an ink for a protective layer including a two-liquid curable resin (main agent: acrylic polyol, curing agent; hexamethylene diisocyanate) and a matting agent (silica particles having an average particle size of 2 μm, 23 parts by mass with respect to 100 parts by mass of the resin components in the protective layer), and drying. Then, a raised layer including a plurality of raised portions was formed by coating a part of the protective layer with an ink for a raised layer 6 having the following formula, and drying. After that, a decorative sheet in Example 6 was obtained by heating and curing at 70° C. for 24 hours. Incidentally, the raised portion was formed so that the ratio of the area of the raised layer with respect to the area of the protective layer in the thickness direction, the average distance between adjacent raised portions, and the average thickness T4 of the raised layer were the values shown in Table 1.

### <Ink for Raised Layer 6>

Two-liquid curable resin 100 parts by mass (main agent: acrylic polyol, curing agent: hexamethylene diisocyanate)
Organic particles 7.6 parts by mass (spherical polymethyl methacrylate particles, average particle size of 50 μm)
Inorganic particles 15 parts by mass (silica particles, average particle size of 8 μm).
Solvent appropriate quantities (butyl acetate, ethyl acetate)

### Comparative Examples 1 to 3

### (Production of Decorative Sheet)

As a substrate, colored base paper for construction materials (“CHPS 45 (model number)”, basis weight: 45 g/m² from Tentok Corporation) was prepared. A solid layer having a thickness of 5 μm was formed by coating one surface of the substrate with a resin composition including an acrylic resin as a binder, titanium white, Bengal red and lead yellow as colorants, by gravure printing method. Then, a pattern layer with a wood-grain pattern was formed on the solid layer by using a resin composition including cellulose nitrate as a binder and a colorant including Bengal red as a main component. Thereby, a design layer including the solid layer and pattern layer was formed on the substrate. Then, a protective layer having an average thickness of 3 μm was formed by coating the entire surface of the design layer with an ink for a protective layer including a two-liquid curable resin (main agent: acrylic polyol, curing agent: hexamethylene diisocyanate) and a matting agent (silica particles having an average particle size of 2 μm, 23 parts by mass with respect to 100 parts by mass of the resin components in the protective layer), and drying. Then, a raised layer including a plurality of raised portions was formed by coating a part of the protective layer with an ink for a raised layer 7 having the following formula, and drying. After that, decorative sheets in Comparative Examples 1 to 3 were obtained by heating and curing at 70° C. for 24 hours. Incidentally, the raised portion was formed so that the ratio of the area of the raised layer with respect to the area of the protective layer in the thickness direction, the average distance between adjacent raised portions, and the average thickness T4 of the raised layer were the values shown in Table 2.

### <Ink for Raised Layer 7>

Two-liquid curable resin 100 parts by mass (main agent: acrylic polyol, curing agent: hexamethylene diisocyanate)
Organic particles 16 parts by mass (spherical polymethyl methacrylate particles, average particle size of 50 μm)
Solvent appropriate quantities (butyl acetate, ethyl acetate)

### Comparative Example 4

### (Production of Decorative Sheet)

As a substrate, colored base paper for construction materials (“CHPS 45 (model number)”, basis weight: 45 g/m² from Tentok Corporation) was prepared. A solid layer having a thickness of 5 μm was formed by coating one surface of the substrate with a resin composition including an acrylic resin as a binder, titanium white, Bengal red and lead yellow as colorants, by gravure printing method. Then, a pattern layer with a wood-grain pattern was formed on the solid layer by using a resin composition including cellulose nitrate as a binder and a colorant including Bengal red as a main component. Thereby, a design layer including the solid layer and pattern layer was formed on the substrate. Then, a protective layer having an average thickness of 3 μm was formed by coating the entire surface of the design layer with an ink for a protective layer including a two-liquid curable resin (main agent: acrylic polyol, curing agent: hexamethylene diisocyanate) and a matting agent (silica particles having an average particle size of 2 μm, 23 parts by mass with respect to 100 parts by mass of the resin components in the protective layer), and drying. Then, a raised layer including a plurality of raised portions was formed by coating a part of the protective layer with an ink for a raised layer 8 having the following formula, and drying. After that, a decorative sheet in Comparative Example 4 was obtained by heating and curing at 70° C. for 24 hours. Incidentally, the raised portion was formed so that the ratio of the area of the raised layer with respect to the area of the protective layer in the thickness direction, the average distance between adjacent raised portions, and the average thickness of the raised layer were the values shown in Table 2.

### <Ink for Raised Layer 8>

Two-liquid curable resin 100 parts by mass (main agent: acrylic polyol, curing agent: hexamethylene diisocyanate)
Organic particles 16 parts by mass (spherical polymethyl methacrylate particles, average particle size of 30 μm)
Solvent appropriate quantities (butyl acetate, ethyl acetate)

### Comparative Example 5

### (Production of Decorative Sheet)

As a substrate, colored base paper for construction materials (“CHPS 45 (model number)”, basis weight: 45 g/m² from Tentok Corporation) was prepared. A solid layer having a thickness of 5 μm was formed by coating one surface of the substrate with a resin composition including an acrylic resin as a binder, titanium white, Bengal red and lead yellow as colorants, by gravure printing method. Then, a pattern layer with a wood-grain pattern was formed on the solid layer by using a resin composition including cellulose nitrate as a binder and a colorant including Bengal red as a main component. Thereby, a design layer including the solid layer and pattern layer was formed on the substrate. Then, a protective layer having an average thickness of 5 μm was formed by coating the entire surface of the design layer with an ink for a protective layer including a two-liquid curable resin (main agent: acrylic polyol, curing agent: hexamethylene diisocyanate) and a matting agent (silica particles having an average particle size of 2 μm, 23 parts by mass with respect to 100 parts by mass of the resin components in the protective layer), and drying. Then, a raised layer including a plurality of raised portions was formed by coating a part of the protective layer with an ink for a raised layer 7 having the formula described above, and drying. After that, a decorative sheet in Comparative Example 5 was obtained by heating and curing at 70° C. for 24 hours. Incidentally, the raised portion was formed so that the ratio of the area of the raised layer with respect to the area of the protective layer in the thickness direction, the average distance between adjacent raised portions, and the average thickness T4 of the raised layer were the values shown in Table 2.

### [60° Gloss Value of Protective Layer and Raised Layer]

The 60° gloss value of the raised layer and protective layer of the decorative sheet obtained in Examples and Comparative Examples were measured by the following method. The results are shown in Table 1 and Table 2.

### (Method for Measuring)

Disposing a decorative sheet so that the raised layer side was on the upper side, and from the raised layer side, and using a gloss meter (Micro-gloss (model name) from BYK-Gardner GmbH), the specular glossiness at 60° of the raised layer was measured according to Method 3 of JIS Z 8741:1997. The 60° gloss value of the raised layer was an average value of the measured value at arbitrary 10 locations in the raised portion. At each measurement point, the measurement was carried out so that the raised portion was at the center of the measurement site of the gloss meter, and that 50% or more of the area of the measurement site overlapped with the raised portion. Also, the specular glossiness at 60° of the protective layer was measured by the same method.

### [Sense of Authenticity Evaluation]

A total of 20 examinees, five people in their 20s, 30s, 40s, and 50s respectively, evaluated the sense of authenticity of the decorative sheets obtained in Examples and Comparative Examples. The sense of authenticity deriving from the raised layer and protective layer was evaluated by visually observing the decorative sheet from the raised layer side. The evaluation was carried out under fluorescent lighting in a room wherein outside light was blocked, and based on the following evaluation criteria. The sense of authenticity was evaluated based on the evaluation criteria determining sufficient and not too much gloss difference between the portion provided with the raised portion and the portion not provided with the raised portion.

### (Evaluation Criteria)

A: 15 or more out of 20 felt the sense of authenticity.
B: 11 or more and 14 or less out of 20 felt the sense of authenticity.
C: 5 or more and 10 or less out of 20 felt the sense of authenticity.
D: 4 or less out of 20 felt the sense of authenticity.

### [Texture Evaluation]

A total of 20 examinees, five people in their 20s, 30s, 40s, and 50s respectively, evaluated the texture of the decorative sheets obtained in Examples and Comparative Examples. Each examinee touched the raised layer side surface of the decorative sheet with the belly of the index finger of the dominant hand to evaluate whether the texture was high or not. The texture was evaluated based on the evaluation criteria whether “convexoconcave was felt strongly or not”.

### (Evaluation Criteria)

A: 15 or more out of 20 felt the texture.
B: 11 or more and 14 or less out of 20 felt the texture.
C: 5 or more and 10 or less out of 20 felt the texture.
D: 4 or less felt the texture.

### [Abrasion Resistance Evaluation]

For the decorative sheets obtained in Examples and Comparative Examples, the raised layer side surface was subjected to abrasion resistance test by the method according to the regulations of JIS K7204. As for the test conditions, the load of the two abrasion wheels (CS-10) was respectively 500 g and the rotation speed was 250 rpm. After the abrasion resistance test, the decorative sheet was visually checked, the ratio of remaining pattern was determined, and evaluated according to the following evaluation criteria.

### (Evaluation Criteria)

A: the ratio of remaining pattern was 90% or more
B: the ratio of remaining pattern was 70% or more and less than 90%
C: the ratio of remaining pattern was 50% or more and less than 70%
D: the ratio of remaining pattern was less than 50%

### [Evaluation of Cellophane Tape Resistance]

In the decorative sheets obtained in Examples and Comparative Examples, Cellotape (registered trademark) (from NICHIBAN Co., Ltd., 24 mm width) having a size of 60 mm×24 mm was closely adhered onto the raised layer side surface. Then, the tape was quickly peeled off at an angle of 45°. This was repeated for 10 times and the presence or absence of peeled portion after the test was evaluated.
A: no peel
B: a peel occurred

| | | Example | Example | Example | Example | Example | Example |
|---|---|---|---|---|---|---|---|
| | | 1 | 2 | 3 | 4 | 5 | 6 |
| Raised | Area ratio [%] | 40.05 | 40.05 | 40.05 | 40.05 | 40.05 | 23.45 |
| layer | Filler | Urethane | Acrylic | Acrylic | Silica | Acrylic | Acrylic |
| | (Ave. particle size) | beads | beads | beads | (3 μm) | beads | beads |
| | | (50 μm) | (50 μm) | (50 μm) | | (50 μm) | (50 μm) |
| | | | Silica | Silica | | Silica | Silica |
| | | | (3 μm) | (12 μm) | | (6 μm) | (8 μm) |
| | Ave. distance [mm] | 2.5 | 2.3 | 3.0 | 2.8 | 2.5 | 5.3 |
| | Ave. thickness T4 [μm] | 25 | 20 | 20 | 30 | 25 | 20 |
| | 60° gloss value | 15 | 15 | 8 | 10 | 10 | 9 |
| Protec- | Ave. thickness T3 [μm] | 5 | 5 | 5 | 5 | 8 | 1 |
| tive layer | 60° gloss value | 1 | 1 | 1 | 1 | 1 | 1 |

| | | | | | | |
|---|---|---|---|---|---|---|
| Sense of authenticity | B | B | A | A | A | A |
| Texture | A | B | B | A | B | B |
| Abrasion resistance | B | B | B | B | A | D |
| Cellophane tape resistance | A | A | A | A | A | B |

| | | Comp. | Comp. | Comp. | Comp. | Comp. |
|---|---|---|---|---|---|---|
| | | Ex. 1 | Ex. 2 | Ex. 3 | Ex. 4 | Ex. 5 |
| Raised | Area ratio [%] | 23.45 | 13.68 | 60.00 | 60.00 | 23.45 |
| layer | Filler | Acrylic | Acrylic | Acrylic | Acrylic | Acrylic |
| | (Ave. particle size) | beads | beads | beads | beads | beads |
| | | (50 μm) | (50 μm) | (50 μm) | (30 μm) | (50 μm) |
| | Ave. distance [mm] | 5.3 | 4.8 | 1.0 | 1.0 | 5.2 |
| | Ave. thickness T4 [μm] | 20 | 20 | 20 | 10 | 15 |
| | 60° gloss value | 25 | 25 | 25 | 15 | 25 |
| Protec- | Ave. thickness T3 [μm] | 3 | 3 | 3 | 3 | 5 |
| tive layer | 60° gloss value | 1 | 1 | 1 | 1 | 1 |

| | | | | | |
|---|---|---|---|---|---|
| Sense of authenticity | D | D | D | C | D |
| Texture | C | C | D | D | C |
| Abrasion resistance | C | C | C | D | B |
| Cellophane tape resistance | B | B | B | B | A |

As shown in Table 1, it was confirmed that the decorative sheets obtained in Examples 1 to 6 had strong texture while being authentic. Meanwhile, as shown in Table 2, it was confirmed that, since organic particles having large average particle size were used for the raised layer in the decorative sheets obtained in Comparative Examples 1 to 5, the gloss value of the raised layer was high, and was inferior in sense of authenticity. Also, it was confirmed that, since the average distance between the raised portions was short in the decorative sheets obtained in Comparative Example 3 and Comparative Example 4, strong texture was not obtained.

As described above, in the present disclosure, for example, the following inventions are provided.

[1]

A decorative sheet comprising a substrate layer, a design layer, a protective layer, and a raised layer including a raised portion in a pattern, in this order in a thickness direction, wherein
a 60° gloss value of the protective layer is less than a 60° gloss value of the raised layer;
the 60° gloss value of the raised layer is 20 or less;
in the thickness direction, a ratio of an area of the raised layer, with respect to an area of the protective layer, is 10% or more; and
an average distance between adjacent raised portions is 1.6 mm or more.
   [2]

The decorative sheet according to [1], wherein the 60° gloss value of the protective layer is 3 or less.

[3]

The decorative sheet according to [1] or [2], wherein the 60° gloss value of the raised layer is 4 or more.

[4]

The decorative sheet according to any one of [1] to [3], wherein the average distance between adjacent raised portions is 4.0 mm or less.

[5]

The decorative sheet according to any one of [1] to [4], wherein an average thickness of the raised layer is 2 times or more with respect to an average thickness of the protective layer.

[6]

The decorative sheet according to any one of [1] to [5], wherein the average thickness of the raised layer is 15 μm or more.

[7]

The decorative sheet according to any one of [1] to [6], wherein the average thickness of the protective layer is 5 μm or more.

[8]

The decorative sheet according to any one of [1] to [7], wherein the raised portion includes a filler.

[9]

The decorative sheet according to [8], wherein the filler is an inorganic particle.

[10]

The decorative sheet according to [9], wherein a content of the inorganic particle in the raised portion, with respect to 100 parts by mass of resin components in the raised portion, is 2 parts by mass or more and 38 parts by mass or less.

[11]

The decorative sheet according to [9] or [10], wherein an average particle size of the inorganic particle is 2 μm or more and 12 μm or less.

[12]

The decorative sheet according to [8], wherein the filler is an organic particle.

[13]

The decorative sheet according to [12], wherein a content of the organic particle in the raised portion, with respect to 100 parts by mass of resin components in the raised portion, is 7 parts by mass or more and 38 parts by mass or less.

[14]

The decorative sheet according to or [13], wherein an average particle size of the organic particle is 20 μm or more and 60 μm or less.

[15]

A decorative member comprising:
a base member; and
the decorative sheet according to any one of [1] to [14].

### REFERENCE SIGNS LIST

1: substrate layer
2: design layer
3: protective layer
4: raised layer
4a: raised portion
10: decorative sheet

1. A decorative sheet comprising a substrate layer, a design layer, a protective layer, and a raised layer including a raised portion in a pattern, in this order in a thickness direction, wherein
a 60° gloss value of the protective layer is less than a 60° gloss value of the raised layer;
the 60° gloss value of the raised layer is 20 or less;
in the thickness direction, a ratio of an area of the raised layer, with respect to an area of the protective layer, is 10% or more; and
an average distance between adjacent raised portions is 1.6 mm or more.

2. The decorative sheet according to claim 1, wherein the 60° gloss value of the protective layer is 3 or less.

3. The decorative sheet according to claim 1, wherein the 60° gloss value of the raised layer is 4 or more.

4. The decorative sheet according to claim 1, wherein the average distance between adjacent raised portions is 4.0 mm or less.

5. The decorative sheet according to claim 1, wherein an average thickness of the raised layer is 2 times or more with respect to an average thickness of the protective layer.

6. The decorative sheet according to claim 1, wherein the average thickness of the raised layer is 15 μm or more.

7. The decorative sheet according to claim 1, wherein the average thickness of the protective layer is 5 μm or more.

8. The decorative sheet according to claim 1, wherein the raised portion includes a filler.

9. The decorative sheet according to claim 8, wherein the filler is an inorganic particle.

10. The decorative sheet according to claim 9, wherein a content of the inorganic particle in the raised portion, with respect to 100 parts by mass of resin components in the raised portion, is 2 parts by mass or more and 38 parts by mass or less.

11. The decorative sheet according to claim 9, wherein an average particle size of the inorganic particle is 2 μm or more and 12 μm or less.

12. The decorative sheet according to claim 8, wherein the filler is an organic particle.

13. The decorative sheet according to claim 12, wherein a content of the organic particle in the raised portion, with respect to 100 parts by mass of resin components in the raised portion, is 7 parts by mass or more and 38 parts by mass or less.

14. The decorative sheet according to claim 12, wherein an average particle size of the organic particle is 20 μm or more and 60 μm or less.

15. A decorative member comprising:
a base member; and
the decorative sheet according to claim 1.
